(19) United States
(12) Patent Application Publication
(10) Pub. No.: US 2003/0227115 A1
(43) Pub. Date: Dec. 11, 2003

(54) Spring

(76) Inventors: Darcy Pelletier, Legal (CA); Daniel Lawrence Orchard, Wetaskiwin (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/454,951

(22) Filed: Jun. 5, 2003

(30) Foreign Application Priority Data
Jun. 10, 2002 (CA) 2,389,997

(51) Int. Cl. F16F 1/06

(52) U.S. Cl. 267/166

(57) ABSTRACT

A spring includes at least one biasing element, a first member and a second member. The at least one biasing element is integrally formed with the first member and the second member and adapted to bias the first member and the second member either toward each other or away from each other. A mounting element extends from the at least one biasing element. This enables the at least one biasing element to be suspended from a support structure. The provision of a mounting element extending from the biasing element enables the spring to be suspended from a support structure.

### FIELD OF THE INVENTION

The present invention relates to a novel spring construction.

### BACKGROUND OF THE INVENTION

Canadian Patent Application 2,310,164, entitled “Method and Apparatus for Securing a Bottle to a Pet Cage”, describes a method of securing a bottle to a pet cage using a spring. In such application, the positioning of the spring relative to the pet cage was problematic due to the fact that the spacing between the bars of the pet cages was not consistent as between various makes and models of pet cages. Attaching the spring was only possible by working from the inside of the cage to extend the spring through the bars of the pet cage.

### SUMMARY OF THE INVENTION

What is required is new form of spring construction which will be easier to use with pet cages and other applications in which positioning of a spring relative to a support structure is problematic.

According to the present invention there is provided a spring which includes at least one biasing element, a first member and a second member. The at least one biasing element is integrally formed with the first member and the second member and adapted to bias the first member and the second member either toward each other or away from each other. A mounting element extends from the at least one biasing element. This enables the at least one biasing element to be suspended from a support structure.

The provision of a mounting element extending from the coil biasing element enables the spring, as described above, to be suspended from a pet cage, or any other support structure. This enables the spring to be installed without having access to both sides of the support structure. Although a single coil biasing element may be used in some applications, it is envisaged that for most applications there will be a pair of coil biasing elements in spaced apart relation. The coil biasing elements need not be limited to a single coil. Beneficial results have been obtained through the use of coil biasing elements having a dual coil. The dual coil exerts a more gentle pressure than a single coil and was, therefore, found to be better suited to hold the water bottle for pets. Although the form of mounting element may vary, beneficial results have been obtained when the mounting element is a hook.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a spring constructed in accordance with the teachings of the present invention.

FIG. 2 is a side elevation view of the spring illustrated in FIG. 1.

FIG. 3 is a side elevation view of the spring illustrated in FIG. 1, in use suspending a water bottle from a pet cage.

### DETAILED DESCRIPTION OF THE PREFERRED EMBODIMENT

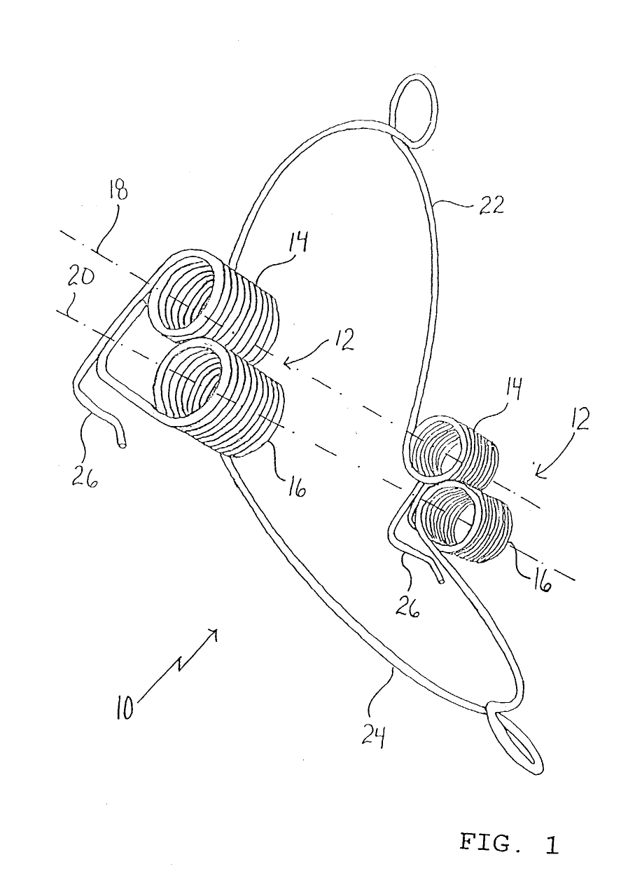

The preferred embodiment, a spring generally identified by reference numeral 10, will now be described with reference to FIGS. 1 through 3.

Structure and Relationship of Parts:

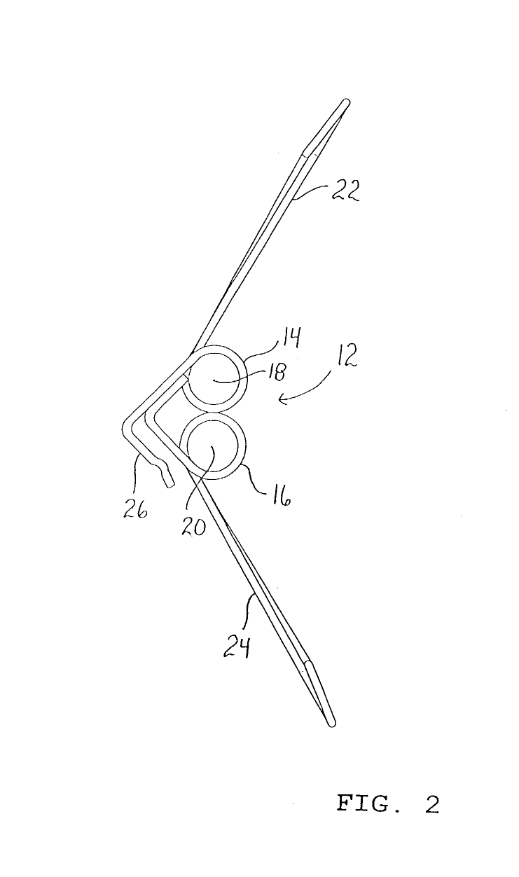

Referring to FIG. 1, spring 10 includes a pair of wire dual coil biasing elements 12. Each dual coil biasing element 12 has a first coil 14 and a second coil 16. First coil 14 of each of respective dual coil biasing elements 12 has a common axis 18 and is positioned in spaced apart relation. Second coil 16 of respective dual coil biasing elements 12 also has a common axis 20 and is positioned in spaced apart relation. Referring to FIGS. 1 and 2, a first member 22 of wire extends between pair of dual coil biasing elements 12. A second member 24 of wire extends between pair of dual coil biasing elements 12. Pair of dual coil biasing elements 12 are integrally formed out of wire with first member 22 and second member 24 and, in the illustrated embodiment, are adapted to bias first member 22 and second member 24 away from each other.

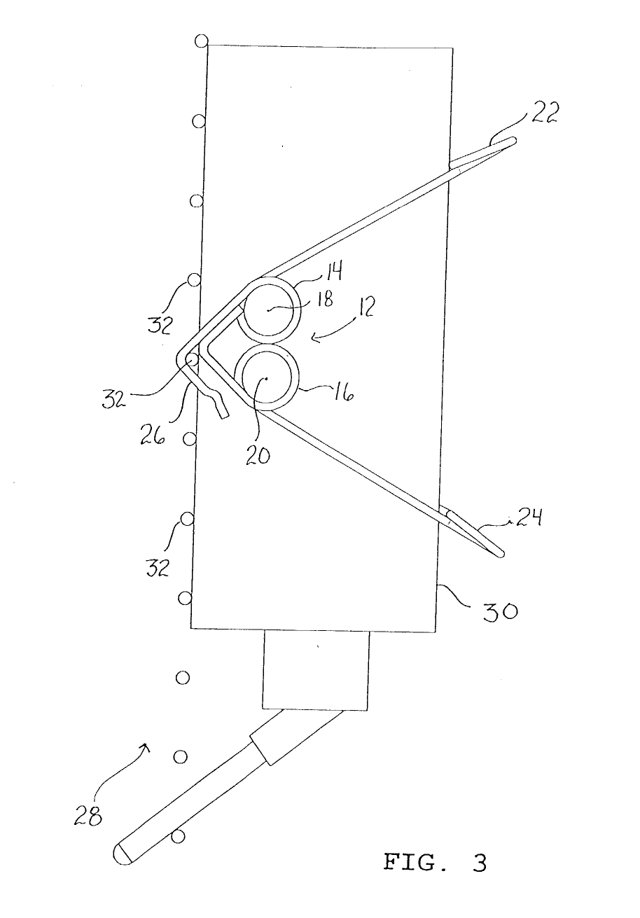

Referring to FIG. 3, mounting hooks 26 extend from each of dual coil biasing elements 12, whereby dual coil biasing elements 12 may be suspended from a support structure such as a pet cage 28, as will hereinafter be further described.

Operation:

The use and operation of spring generally identified by reference numeral 10, will now be described with reference to FIGS. 1 through 3.

Referring to FIG. 3, there is illustrated an example of spring 10 being used to securing a bottle 30 to pet cage 28. Hooks 26 are used to suspend spring 10 from bars 32 of pet cage 28. Bottle 30 is positioned between dual coil biasing elements 12 and first member 22 and second member 24 while spring 10 is compressed. When spring 12 is released, the biasing force of spring 12 acts upon first member 22 and second member 24 to force them apart. In doing so, bottle 30 is forced securely against bars 32. While spring 10 is shown in use with pet cage 28 and bottle 30, it will be appreciated that spring 10 could be used with other support structures and for use in holding other types of items.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A spring, comprising:
at least one biasing element
a first member;
a second member;
the least one biasing element being integrally formed with the first member and the second member and adapted to bias the first member and the second member one of toward each other or away from each other; and
a mounting element extending from the at least one biasing element, whereby the at least one biasing element can be suspended from a support structure.

2. The spring as defined in claim 1, wherein the at least one biasing element is a coil.

3. The spring as defined in claim 1, wherein there is provided a pair of biasing elements in spaced apart relation.

4. The spring as defined in claim 2, wherein the at least one coil biasing element has a dual coil.

5. The spring as defined in claim 1, wherein the mounting element is a hook.

6. The spring as defined in claim 1, wherein the first member and the second member are wire.

7. A spring, comprising:
a pair of wire coil biasing elements having a common axis and being positioned in spaced apart relation;
a first member of wire extending between the pair of coil biasing elements;
a second member of wire extending between the pair of coil biasing elements;
the pair of wire coil biasing elements being integrally formed with the first member and the second member and adapted to bias the first member and the second member one of toward each other or away from each other; and
mounting elements extending from each of the coil biasing elements, whereby the coil biasing elements are suspended from a support structure.

8. The spring as defined in claim 7, wherein coil biasing elements have a dual coil.

9. The spring as defined in claim 7, wherein the mounting element is a hook.

10. A spring, comprising:
a pair of wire dual coil biasing elements each having a first coil and a second coil, the first coil of the respective dual coil biasing elements having a common axis and being positioned in spaced apart relation, the second coil of the respective dual coil biasing elements having a common axis and being positioned in spaced apart relation;
a first member of wire extending between the pair of dual coil biasing elements;
a second member of wire extending between the pair of dual coil biasing elements;
the pair of dual coil biasing elements being integrally formed with the first member and the second member and adapted to bias the first member and the second member away from each other; and
mounting hooks extending from each the dual coil biasing elements, whereby the dual coil biasing elements are suspended from a support structure.
